(19) United States
(12) Patent Application Publication
(10) Pub. No.: US 2010/0209708 A1
(43) Pub. Date: Aug. 19, 2010

(54) CROSSLINKED CELLULOSE BEADS

(75) Inventors: Markus Braun, Heidelberg (DE); Rainer Dyllick-Brenzinger, Neustadt (DE); Matthias Maase, Mendham, NJ (US); Frank Stein, Bad Duerkheim (DE); Megan Turner, Florham Park, NJ (US); Eric Uerdingen, Speyer (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Basf SE, Ludwigshafen (DE)

(21) Appl. No.: 12/676,488

(22) PCT Filed: Sep. 9, 2008
(86) PCT No.: PCT/EP2008/061900

§ 371 Date: Mar. 4, 2010

Related U.S. Application Data
(60) Provisional application No. 60/972,949, filed on Sep. 17, 2007.

(51) Int. Cl. B32B 5/00; C08B 1/00

(52) U.S. Cl. 428/402; 536/56

(57) ABSTRACT

Crosslinked cellulose beads or lignocellulose beads (referred to as beads for short), wherein at least 50% by weight of the beads have a particle diameter greater than 800 μm (21° C., 1 bar, determined by sieve analysis).

The invention relates to crosslinked cellulose beads or lignocellulose beads (referred to as beads for short), at least 50% by weight of the beads having a particle diameter greater than 800 μm (21° C., 1 bar, determined by sieve analysis).

Cellulose is a raw material available in large amounts and can be obtained by various digestion processes from wood. Depending on the type of digestion process and the manner in which it is carried out, the cellulose obtained also comprises lignin as a constituent (lignocellulose).

The cellulose can be processed to give fibers, which in turn are used for the production of textiles. The use which has not been very important to date is the processing of cellulose to give beads. Such beads are used, for example, as filling and carrier material in chromatography columns, as described, for example, in EP-A-264 853. The beads described there are relatively small and have a mean particle diameter of less than 300 μm.

For further uses of cellulose beads, beads as large as possible and of high strength are required or desirable. Large beads having sufficient strength are generally advantageous in transport, storage and disposal.

The preparation of large beads by coagulation of industrial viscose (cellulose content 8.2%) is described in U.S. Pat. No. 4,055,510; after drying, 85% by volume of the beads according to example 1 of the US patent have a particle diameter of from 0.15 to 0.35 mm. However, these beads still do not have sufficient strength and are therefore not suitable for uses in which the strength and in particular the avoidance of small-particle abrasion or decomposition products due to impact or shear loads are important.

The crosslinking of cellulose fibers with crosslinking agents is generally known and is described, for example, in Absorbent Technology, P. K. Chatterjee and B. S. Gupta, 2002, Elsevier Science B.V. U.S. Pat. No. 3,545,913 describes paraformaldehyde, U.S. Pat. No. 3,776,692 describes polycarboxylic acids and EP 251 676 describes dialdehydes as crosslinking agents. Epichlorohydrin is also used as a crosslinking agent in the abovementioned EP 264 853, which relates to cellulose beads.

An object of the present invention was cellulose or lignocellulose beads which are as large and strong as possible and, owing to their size and strength, are advantageous in storage, transport and disposal and have advantageous performance characteristics, for example a high impact strength and low abrasion in the desired use.

Accordingly, the crosslinked beads defined at the outset were found.

### Regarding the Beads

At least 50% by weight, in particular at least 80% by weight, very particularly preferably at least 90% by weight, in particular at least 95% by weight, of the crosslinked beads have a particle diameter greater than 800 μm (21° C., 1 bar, determined by sieve analysis).

Preferably, at least 95% by weight, in particular at least 99% by weight, of the crosslinked beads have a particle diameter of less than 1500 μm.

The crosslinked beads preferably have an increase in diameter of less than 20%, in particular less than 10% and very particularly preferably less than 5% or even less than 2% after swelling in 2% strength by weight aqueous potassium chloride solution.

The increase in diameter after swelling is determined as follows:

The crosslinked beads are dried at 105° C. and 1 bar to constant weight. 1 gram of the beads is added to 10 grams of 2% strength by weight potassium chloride solution (at 21° C., 1 bar). After 24 hours, the swollen beads are removed from the solution and the diameter is determined directly thereafter under a microscope without drying and is compared with the diameter of the beads dried at 105° C. and 1 bar to constant weight without swelling.

In the microscopic evaluation, the mean value of the bead diameter of at least 20 beads is determined.

Particularly preferred crosslinked beads have a proportion of at least 50% by weight of beads with a particle diameter greater than 800 μm (21° C., 1 bar, determined by sieve analysis) and an increase in diameter of less than 5% by weight, in particular less than 2% by weight, after swelling.

The beads substantially comprise cellulose or lignocellulose.

The term cellulose is understood here as meaning natural or subsequently chemically modified cellulose. Suitable chemically modified cellulose is, for example, cellulose ester, cellulose ether, cellulose reacted with amino compounds or subsequently crosslinked cellulose. Cellulose acetate and cellulose butyrate may be mentioned in particular as cellulose esters, and carboxymethylcellulose, methylcellulose and hydroxyethylcellulose may be mentioned in particular as cellulose ethers. Cellulose allophanates and cellulose carbamates may furthermore be mentioned.

In particular, the molecular weight of the natural cellulose can also be reduced by chemical or enzymatic degradation reactions or by addition of bacteria (bacterial degradation). The cellulose may also comprise low molecular weight polysaccharides, so-called polyoses or hemicelluloses (degree of polymerization in general only from 50 to 250); the proportion of such low molecular weight constituents is, however, in general less than 10% by weight, in particular less than 5% by weight or less than 3% by weight, based on the cellulose.

The term lignocellulose is understood as meaning natural or modified cellulose, as described above, which is present as a mixture with lignin or may be chemically bonded to lignin.

Suitable beads may consist of cellulose or of lignocellulose. In the case of lignocellulose and of the beads obtained therefrom, the proportion of lignin is, for example, from 5 to 60% by weight, in particular from 5 to 40% by weight, based on the total weight of the beads.

The beads may comprise further constituents or additives, for example stabilizers and in particular biocides. In a particular embodiment, the beads comprise biocides, preferably in an amount of from 0.1 to 3% by weight.

### Preparation of the Beads

As already mentioned at the outset, cellulose or lignocellulose can be obtained by various digestion processes from wood. The working-up of the suspensions obtained thereby and, if appropriate, modification of the cellulose or lignocellulose obtained are known.

The preparation of beads can be effected by first coagulating suspensions comprising cellulose or lignocellulose, as described, for example, in U.S. Pat. No. 4,055,510.

Before the crosslinking described below, the beads preferably already have the desired minimum size (see above).

The beads according to the invention are obtainable by crosslinking beads at least 50% by weight of which have a particle diameter greater than 800 μm (21° C., 1 bar, determined by sieve analysis) with a crosslinking agent.

Suitable crosslinking agents are in particular low molecular weight ones and have a molecular weight of less than 1000 g/mol, particularly preferably less than 500 g/mol and very particularly preferably less than 250 g/mol.

Preferred crosslinking agents are soluble in water at 21° C., 1 bar.

In a preferred embodiment, suitable crosslinking agents are compounds having at least one carbonyl group.

A suitable crosslinking agent having a carbonyl group is in particular formaldehyde or a formaldehyde-liberating compound, such as paraformaldehyde or formalin.

In particular, C2 to C8 dialdehyde may be mentioned as a crosslinking agent having a plurality of carbonyl groups; a particularly preferred dialdehyde is glyoxal.

A further group of suitable crosslinking agents comprises compounds having at least one carboxyl group. Here, carboxyl group is understood as meaning a carboxylic acid group or the salt thereof. In particular, compounds having from 2 to 5 carboxyl groups, preferably carboxylic acid groups, are suitable. Aliphatic compounds are particularly preferred. Citric acid may be mentioned by way of example.

Furthermore, compounds having at least one epoxy group are suitable as crosslinking agents. A preferred compound having an epoxy group is epichlorohydrin. Furthermore, compounds having 2 or more, for example 2 to 5, in particular 2, epoxy groups are suitable.

Compounds having at least one isocyanate or carbodiimide group are also suitable crosslinking agents.

Preferred crosslinking agents are compounds having at least one carbonyl group, preferably at least one aldehyde group, e.g. formaldehyde.

Particularly preferred crosslinking agents are compounds having a plurality of carbonyl groups, in particular aldehyde groups, for example having 2 to 4 carbonyl groups or aldehyde groups.

In a very particularly preferred embodiment, C2 to C8 dialdehydes, in particular glyoxal, are used as crosslinking agents.

For the preparation of the crosslinked beads, uncrosslinked or precrosslinked beads having the desired size (see above) are crosslinked with a crosslinking agent.

The crosslinking agent can be brought into contact with the beads in any desired manner. The beads can, for example, be impregnated with the crosslinking agent, the beads can be added to a solution of the crosslinking agent or the crosslinking agent can be added to a suspension of the beads. The crosslinking agent may also be gaseous (formaldehyde) and the beads can be treated with this gas.

Particularly preferably, the beads and the crosslinking agent are brought into contact with one another in water, in a water-miscible solvent or in a mixture thereof.

Preferably from 1 to 60 parts by weight, particularly preferably from 2 to 50 parts by weight and very particularly preferably from 10 to 50 parts by weight of crosslinking agent are used per 100 parts by weight of beads.

In a preferred embodiment, the mixture of beads, crosslinking agent and preferably a solvent (selected from water, a water-miscible solvent and mixtures thereof) is stirred for some time, preferably at least 10 minutes, particularly preferably at least 30 minutes but in general not longer than 4 hours. This can be effected at temperatures of, for example, from 0 to 80° C., preferably at from 10 to 40° C., in particular at room temperature (from 18 to 30° C.).

Thereafter, the solvent is separated off; for example, the beads can be filtered off or pressed.

Finally, the beads are dried and crosslinked at elevated temperatures, preferably from 40 to 200° C. In particular, this is effected in two stages, drying first being effected at from 20 to 100° C., preferably at from 40 to 80° C. and the crosslinking then being carried out at higher temperatures, for example from 100 to 200° C. In the case of crosslinking agents comprising carbonyl groups (acetal formation) the crosslinking takes place in particular at from 100 to 150° C.; in the case of crosslinking agents comprising acid groups, it takes place in particular at from 150 to 200° C.

In spite of their size, the crosslinked beads according to the invention are extremely strong. They are therefore advantageous in transport, storage and disposal. When they are used, there is scarcely any abrasion or comminution due to impacts or friction or due to the action of other forces, including shear forces.

### EXAMPLES

### Fine Fraction:

In the examples, fine fraction is understood as meaning beads having a diameter of less than 800 μm.

### Test Methods:

Pressure test:

The crosslinked cellulose beads (dry) were introduced into a cylindrical container and a pressure of 100 kilonewton was exerted on the beads for 2 minutes via a moveable ram. Thereafter, the proportion of crushed beads (fine fraction) was determined.

### Example 1

### Crosslinking with paraformaldehyde

260 g of cellulose beads (moist, corresponds to 33 g of dry cellulose beads, solids content 12.7%) were stirred with 660 g of a crosslinked dispersion comprising 20 parts of 37% strength formalin, 50 parts of 37% strength HCl and 30 parts of demineralized water for 1 h in a beaker at room temperature. Thereafter, the cellulose beads were filtered and were dried in a porcelain dish in a drying oven for 4 h at 110° C.

Swelling value in 2% KCl solution: 6% increase in diameter

Bulk density: 0.87 g/cm³

Sieve size: 400-800 μm (corresponds to US sieve 20/40)

Pressure test: 60.2% fine fraction

### Example 2

### Crosslinking with citric acid (30% by weight in water)

250 g of cellulose beads (moist, corresponds to 33 g of dry cellulose beads, solids content 13.2%) were stirred with 660 g of 20% strength citric acid and 4 g of hypophosphorous acid (1%, based on high-purity citric acid) for 1 h at room temperature. The cellulose beads were filtered off and were dried at 70° C. in a fluidized bed and then crosslinked at 180° C. for 10 minutes.

Swelling value in 2% KCl solution: 10% increase in diameter

Bulk density: 0.96 g/cm³

Sieve size: 800-1800 μm (corresponds to US sieve 12/20)

Pressure test: cannot be determined

### Example 3

### Crosslinking with glyoxal (20% by weight in water)

250 g of cellulose beads (moist, corresponds to 33 g of dry cellulose beads having a solids content of 13.2%) were stirred with 660 g of glyoxal solution (20% strength) at room temperature for 1 h. The beads were filtered off and were dried and crosslinked in a fluidized bed at 120° C. for 70 minutes.

Swelling value in 2% KCl solution: 3% increase in diameter

Bulk density: 0.93 g/cm³

Sieve size: 800-1800 μm (corresponds to US sieve 12/20)

Pressure test: 1.86% fine fraction

1. A crosslinked cellulose bead or lignocellulose bead (referred to as bead for short), wherein at least 50% by weight of the beads have a particle diameter greater than 800 μm at 21° C. and 1 bar, determined by sieve analysis.

2. The bead according to claim 1, which exhibits an increase in diameter of less than 5% after swelling in 2% strength by weight aqueous potassium chloride solution.

3. The bead according to claim 1, which has a content of biocides.

4. The bead according to claim 1, which is obtained by crosslinking beads at least 50% by weight of which have a particle diameter greater than 800 μm at 21° C. and 1 bar, determined by sieve analysis) analysis with a crosslinking agent.

5. The bead according to claim 4, wherein the crosslinking agent is a compound having at least one carbonyl group.

6. The bead according to claim 5, wherein the crosslinking agent is formaldehyde or a formaldehyde-liberating compound.

7. The bead according to claim 5, wherein the crosslinking agent is a C2 to C8 dialdehyde.

8. The bead according to claim 5, wherein the crosslinking agent is glyoxal.

9. The bead according to claim 4, wherein the crosslinking agent is a compound having at least one carboxyl group.

10. The bead according to claim 9, wherein the crosslinking agent is a compound having 2 to 5 carboxylic acid groups.

11. The bead according to claim 10, wherein the crosslinking agent is citric acid.

12. The bead according to claim 4, wherein the crosslinking agent is a compound having at least one epoxy group.

13. The bead according to claim 4, wherein the crosslinking agent is a compound having at least one isocyanate or carbodiimide group.

14. A process for the preparation of beads according to claim 1, wherein beads at least 50% by weight of which have a particle diameter greater than 800 μm at 21° C. and 1 bar, determined by sieve analysis, are crosslinked with a crosslinking agent.

15. The process according to claim 14, wherein at least 10 parts by weight of crosslinking agent are used per 100 parts by weight of beads.

16. The process according to claim 14, wherein the beads are brought into contact with the crosslinking agent in water or in a water-miscible solvent or a mixture thereof and the beads are filtered off, dried at elevated temperatures, and crosslinked.
